(19) United States
(12) Patent Application Publication
(10) Pub. No.: US 2026/0341614 A1
(43) Pub. Date: Oct. 29, 2026

(54) VACUUM SWITCHING TUBE FOR SWITCHING VOLTAGES, AND METHOD FOR COLLECTING PARTICLES IN THE VACUUM SWITCHING TUBE

(71) Applicant: Siemens Energy Global GmbH & Co. KG, München (DE)

(72) Inventors: Thomas Heinz, Berlin (DE); Stefan Giere, Falkensee (DE)

(21) Appl. No.: 18/997,380

(22) PCT Filed: Jul. 7, 2023
(86) PCT No.: PCT/EP2023/068867

§ 371 Date: Jan. 21, 2025

(30) Foreign Application Priority Data
Jul. 21, 2022 (DE) 10 2022 207 491.2

(51) Int. Cl. H01H 33/668; H01H 33/662

(52) U.S. Cl. CPC H01H 33/668; H01H 33/66207

(57) ABSTRACT

A vacuum switching tube for switching voltages, in particular high voltages, and to a method for collecting particles in a vacuum switching tube. The vacuum switching tube has a casing and at least two contact pieces. The casing encloses at least one evacuated switching chamber. The vacuum switching tube has at least one device for collecting particles. Particles, in particular burned-off particles of the contact pieces of the vacuum switching tube, are collected and/or kept away from the contact pieces, in particular by gravitational force, in a device in the form of a chamber.

The invention relates to a vacuum switching tube for switching voltages with at least one sleeve and with at least two contact pieces, wherein the at least one sleeve comprises at least one evacuated switching chamber. The invention furthermore comprises a method for collecting particles in a vacuum switching tube.

Vacuum switching tubes are used, for example, in circuit breakers for switching high voltages and/or currents. Such vacuum switching tubes are employed in medium-voltage and high-voltage engineering for switching voltages in the range above 1 kV in medium-voltage engineering, or greater than or equal to 52 kV in high-voltage engineering, and/or are used for switching high currents in the range of, for example, up to several tens of kiloamperes. Vacuum switching tubes comprise contact pieces or switching contact pieces which can move relative to one another and are arranged in at least one evacuated switching chamber, i.e. a vacuum switching chamber. Movable contact pieces can here be moved by a drive, in parallel via a kinematic chain. The switching chamber comprises, for example, a plurality of ceramic segments, in particular with a hollow cylindrical shape, which are connected, for example, by metal shields. At the ends, the switching chamber is movably mounted in a vacuum-tightly closed manner, via for example a metal cover element in the case of a fixed contact piece, and via for example an in particular metal bellows in the case of a movable contact piece.

In switchgear, in particular in circuit breakers, the vacuum switching tubes are arranged in housings, for example in metal tanks, dead and/or live tanks, and/or in insulated housings, for example ribbed silicone, ceramic, and/or composite housings. The housings are filled with an insulating gas, in particular SF₆ and/or clean air, i.e. synthetic air. The contact pieces of a vacuum switching tube are routed, for example in the form of bolts, into the vacuum switching tube with in each case two opposite plate-shaped ends which are in mechanical and electrical contact with each other in the switched-on state of the vacuum switching tube, and have a gap or spacing from each other in the switched-off state of the vacuum switching tube.

When switching takes place, i.e. when at least one contact piece is moved, and in particular when contact pieces which are connected to each other in the switched-on state are mechanically separated, particles can occur, for example as abraded particles or ripped out, in particular ripped out from surfaces of the plate-shaped regions of the contact pieces. The particles in the vacuum switching tube, in particular deposited or adsorbed on inner surfaces of the ceramic segments, cause electrical and electromagnetic disruption and in extreme cases electrical flashovers between contact pieces in the open state. Electrical flashovers result in restricted functioning of the vacuum switching tubes, for example in circuit breakers, and in extreme cases in irreversible destruction of the vacuum switching tubes.

The object of the invention is to provide a vacuum switching tube for switching voltages, and a method for collecting particles in a vacuum switching tube, which overcome the problems described above. In particular, the object is to prevent particles in the vacuum switching tube resulting in disruption and/or destruction, for example when switching, in the switched-off state and/or because of leakage currents, electrical flashovers, and/or discharges via the particles.

The object is achieved according to the invention by a vacuum switching tube for switching voltages having the features of claim 1 and/or a method for collecting particles in a vacuum switching tube, in particular an above-described vacuum switching tube, according to claim 12. Advantageous embodiments of the vacuum switching tube according to the invention for switching voltages and/or the method according to the invention for collecting particles in a vacuum switching tube are provided in the dependent claims. The subject matter of the main claim can here be combined with features of dependent claims, and features of the dependent claims can be combined with one another.

A vacuum switching tube according to the invention for switching voltages comprises at least one sleeve and at least two contact pieces, wherein the at least one sleeve comprises at least one evacuated switching chamber. According to the invention, at least one device for collecting particles is comprised.

The collecting of particles in a device for collecting particles prevents the particles in the vacuum switching tube from being deposited in an uncontrolled fashion in particular on insulating parts such as, for example, ceramic segments of the sleeve, or being adsorbed thereon. Particles are, for example, burn-up particles from the contact pieces which occur during switching because of arcs, and/or, for example, abraded particles from the contact pieces which occur in particular because of the switching movement. The particles are at least partially electrically conductive, as a result of which particles allow electrical flashovers, at insulating parts, which can damage and/or destroy the vacuum switching tube. The collection of particles reduces and/or prevents the above-described problems by the particles being collected or stored at a non-critical location at which the particles cause no or reduced disruption, in particular do not allow any electrical flashovers. Damage and in extreme cases destruction of the vacuum switching tube is consequently prevented.

The device can be designed to collect the particles by the action of gravity. Gravity is a reliable fail-safe force, the action of which enables the reliable collection of particles. Particles which occur in particular at the contact pieces fall in the direction of the force of gravity or downward in the vacuum switching tube and are collected in the device for collecting particles, with the above-described advantages. As an alternative or in addition to the force of gravity, forces such as, for example, electrostatic and/or electromagnetic forces can also effect collection of particles in the device for collecting particles.

The device can be designed in the manner of a particle trap which acts in particular by sedimentation of the particles from the at least one evacuated switching chamber. Particles are collected in a particle trap and are not released again without any external intervention, in particular by a third party. Sedimentation, i.e. the depositing of particles as sediment, is the settling or depositing of particles under the influence of gravity and/or other forces such as, for example, centrifugal force in the case of rotating systems. The collection and retention of the particles in the device prevents depositing of the particles at insulating parts such as, for example, ceramic segments, with the above-described advantages, and/or the adsorption of particles at the contact pieces, wherein the particles disrupt or prevent the electrical fields during switching and the electrical and/or mechanical contact between contact pieces in the case of adsorption at contact pieces.

The device can be designed as a separate chamber for collecting the particles which in particular effects retention of the particles from the contact pieces. A separate chamber, adjacent to and spatially separated from the switching chamber, with the exception of an opening for the entry of particles into the separate chamber, enables particles to be collected and in particular permanently retained from parts or components in the switching chamber, for example from insulating parts such as, for example, ceramic segments and/or from the contact pieces, with the above-described advantages.

The device can be designed as a chamber, integrated into the sleeve, for collecting the particles which effects in particular retention of the particles from the contact pieces, in particular arranged at the circumference of the vacuum switching tube and along the longitudinal axis of the vacuum switching tube at least partially and/or completely in the region between the contact pieces. Designing the device in the sleeve enables a simple, cost-effective device with good access to the switching chamber for simple and effective collection of particles in the device, in particular in the case of arrangement at the circumference of the vacuum switching tube and along the longitudinal axis of the vacuum switching tube at least partially and/or completely in the region between the contact pieces.

The at least one sleeve can comprise at least one main shield and at least two ceramic segments, in particular with the at least one main shield arranged along the longitudinal axis of the vacuum switching tube between the at least two ceramic segments, wherein the at least one device can be comprised by at least one main shield. The device can be formed in the main shield and/or be arranged on the main shield, in particular outside the sleeve of the vacuum switching tube with an opening leading to the switching chamber, and/or can be spatially comprised by the main shield or be surrounded by the latter. The main shield between the ceramic segments is arranged in the region of the contact pieces, in particular in the contact region of contact pieces with each other, by means of which a device in the main shield and/or comprised by the main shield can in particular collect particles which occur in the region of the mechanical and/or electrical contact between the contact pieces.

The at least one device can have at least one opening, in particular an opening of at least one separate chamber for collecting particles. A separate chamber with one or more openings is very well suited for admitting particles into the chamber and in particular permanently holding them in the chamber, with the above-described advantages.

The at least one device can be formed, in the case of a horizontal position of the vacuum switching tube, in particular with the longitudinal axis of the vacuum switching tube parallel to a horizontal of the earth's surface, in particular exclusively in a lower region of the sleeve of the vacuum switching tube. Particles are effectively collected and retained in such a device in particular by the action of gravity or in the case of sedimentation, wherein the action of gravity, for example in conjunction with in particular a small opening of the chamber of the device leading to the switching chamber, effectively keeps away or retains particles from the switching chamber and collects them, with the above-described advantages.

The at least one device can comprise walls, in particular walls which comprise and/or form at least one opening,
wherein walls are formed so that they slope toward the opening, in particular at a non-zero angle with reference to the longitudinal axis of the vacuum switching tube, and/or
wherein walls can be T-shaped, and/or
wherein walls can be U- and/or V-shaped, in particular with U- and/or V-shaped recesses. The walls allow a chamber or a delimited region to be formed which enables the retention and storage or collection of particles, with the abovementioned advantages. In the case of sloped walls leading to at least one opening, in particular the force of gravity effects a movement of particles or transporting of particles to a respective opening, the passage through the opening, and collection and retention of the particles in the device for collecting the particles. Similarly, U- and/or V-shaped walls enable movement of particles or transporting of particles to at least one collecting region, in particular to the lowest point which is remote from the contact pieces and/or insulating parts such as, for example, ceramic segments, and collection and storage of the particles in this region. T-shaped walls also enable the formation of a chamber or a delimited region which enables the retention and storage or collection of particles, in particular a plurality of T-shaped walls. A combination of walls, in particular with different shapes, is possible for the formation of collecting regions for particles.

The at least one device can have at least an elliptical, square, and/or circular cross section. Further shapes or cross sections, in particular shapes, which form at least one chamber or a delimited region which enables the retention and storage or collection of particles, are possible, with the above-described advantages.

The vacuum switching tube can be designed for switching high voltages, in particular for switching voltages above 52 kV. In the case of high voltages, in particular in the high-voltage range, particles cause the above-described disadvantages, in particular adsorbed in the region of insulating parts such as, for example, ceramic segments and/or at the contact pieces. Flashovers occur at high voltages more intensely on unclean surfaces at which particles are adsorbed. At high voltages, the flashovers cause damage and in extreme cases destruction of vacuum switching tubes and/or can restrict their function in particular during switching.

A method according to the invention for collecting particles in a vacuum switching tube, in particular in an above-described vacuum switching tube, comprises the collecting of the particles, in particular burn-up particles, from contact pieces of the vacuum switching tube and/or the retention thereof from the contact pieces, in particular due to the force of gravity.

The advantages of the method according to the invention for collecting particles in a vacuum switching tube, in particular in an above-described vacuum switching tube, according to claim 12 are similar to the above-described advantages of the vacuum switching tube according to the invention for switching voltages according to claim 1, and vice versa.

Exemplary embodiments of the invention are illustrated schematically below in the figures and described in detail hereinafter. In the drawings:

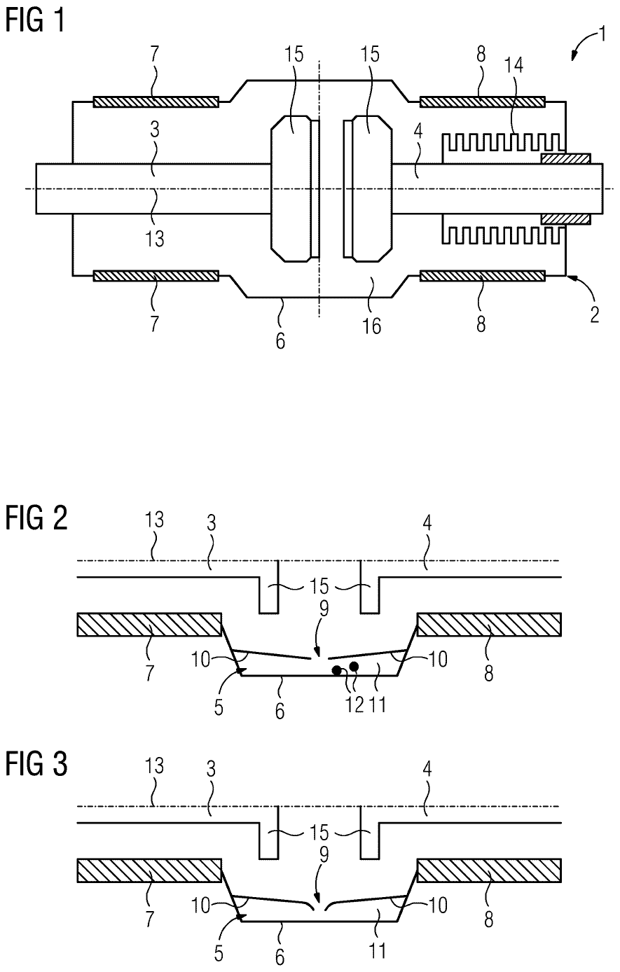

FIG. 1 shows schematically a vacuum switching tube 1 for switching voltages in a view in section from the side, with a sleeve 2 and with two contact pieces 3 and 4, wherein the sleeve comprises an evacuated switching chamber 16, and

FIG. 2 shows schematically a detail of a vacuum switching tube 1 according to the invention, with a structure according to FIG. 1, which comprises a device 5 according to the invention for collecting particles 12, with a chamber 11 with a central opening 9, formed by sloped walls 10, and a main shield 6 of the vacuum switching tube 1, and

FIG. 3 shows schematically a detail of a vacuum switching tube 1 according to the invention, similar to FIG. 2, with sloped walls 10 which are additionally curved toward the opening 9, and

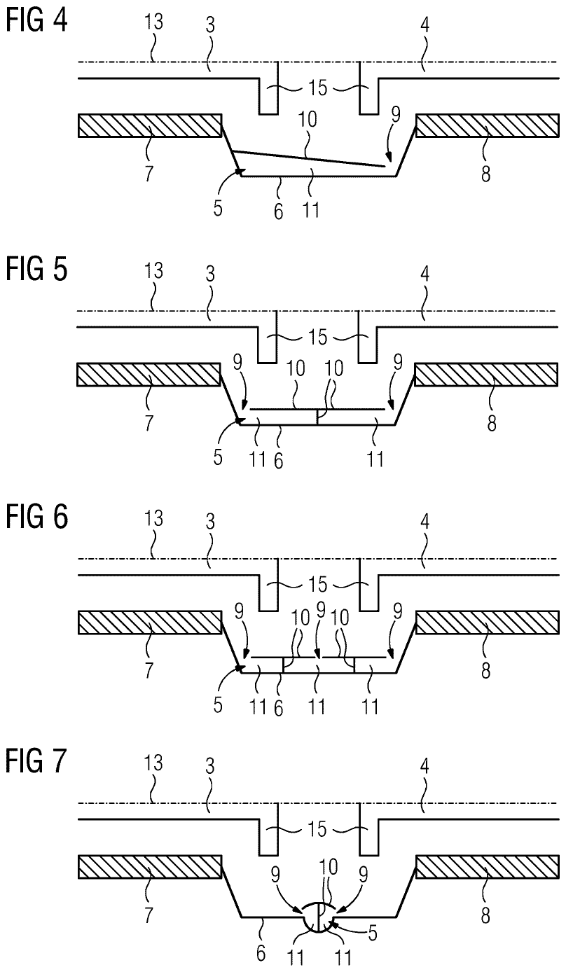

FIG. 4 shows schematically a detail of a vacuum switching tube 1 according to the invention, with a structure according to FIG. 1, which comprises a device 5 according to the invention for collecting particles 12, with a chamber 11 with a lateral opening 9, formed by a sloped wall 10 and a main shield 6 of the vacuum switching tube 1, and

FIG. 5 shows schematically a detail of a vacuum switching tube 1 according to the invention, with a structure according to FIG. 1, which comprises a device 5 according to the invention for collecting particles 12, with two chambers 11 which each have a lateral opening 9, formed by a T-shaped wall 10 and a main shield 6 of the vacuum switching tube 1, and

FIG. 6 shows schematically a detail of a vacuum switching tube 1 according to the invention, with a structure according to FIG. 1, which comprises a device 5 according to the invention for collecting particles 12, with three chambers 11 which each have an opening 9, formed by two T-shaped walls 10 and a main shield 6 of the vacuum switching tube 1, and

FIG. 7 shows schematically a detail of a vacuum switching tube 1 according to the invention, with a structure according to FIG. 1, which comprises a device 5 according to the invention for collecting particles 12, with two chambers 11 which each have an opening 9, formed by a rounded T-shaped wall 10 and a main shield 6 of the vacuum switching tube 1, wherein the main shield 11 comprises a wall 10 formed as a U-shaped recess, and

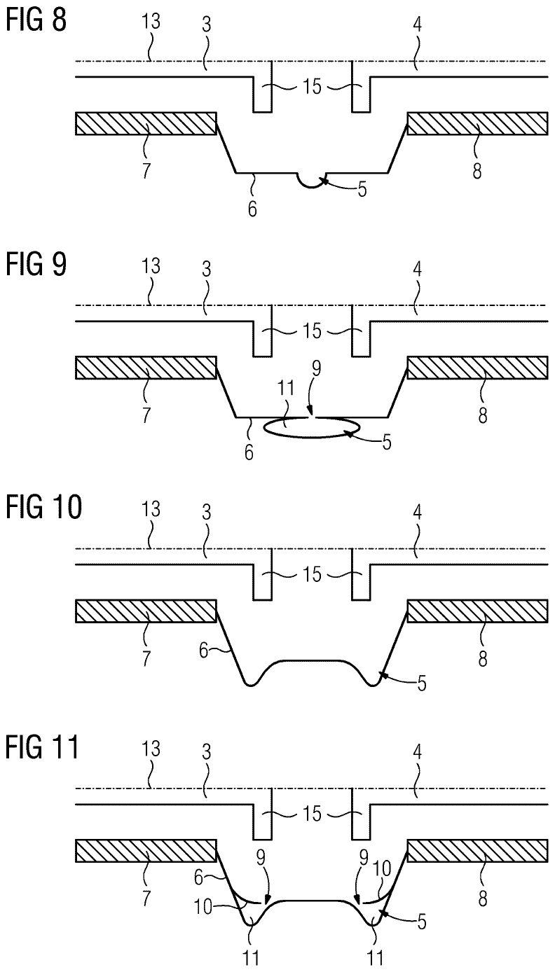

FIG. 8 shows schematically a detail of a vacuum switching tube 1 according to the invention, with a structure according to FIG. 1, which comprises a device 5 according to the invention for collecting particles 12, formed by a main shield 11 of the vacuum switching tube 1, which comprises a wall 10 formed as a U-shaped recess, and

FIG. 9 shows schematically a detail of a vacuum switching tube 1 according to the invention, with a structure according to FIG. 1, which comprises a device 5 according to the invention for collecting particles 12, with a chamber 11 with an elliptical cross section, which has an opening 9, formed by a wall 10 as a recess in a main shield 6 of the vacuum switching tube 1, and

FIG. 10 shows schematically a detail of a vacuum switching tube 1 according to the invention, with a structure according to FIG. 1, which comprises a device 5 according to the invention for collecting particles 12, formed by a main shield 11 of the vacuum switching tube 1 which comprises walls 10 formed as two adjacent, rounded V-shaped recesses, and

FIG. 11 shows schematically a detail of a vacuum switching tube 1 according to the invention, with a structure according to FIG. 1, which comprises a device 5 according to the invention for collecting particles 12, formed by a main shield 11 of the vacuum switching tube 1 which comprises walls 10 formed as two adjacent, rounded V-shaped recesses, which are each provided with a sloped, curved wall 10 as a cover, which results in each case in an opening 9.

A vacuum switching tube 1 according to the invention for switching voltages, in particular high voltages in the range equal to or above 52 kV is illustrated schematically in FIG. 1 by way of example in a view in section from one side. The vacuum switching tube 1 has a sleeve 2 which comprises inter alia a central main shield 6 and in each case a first and second ceramic segment 7, 8 which adjoin it flush to the right and left. The main shield 6 and the ceramic segments 7, 8 are formed with a hollow cylindrical or tubular shape, arranged with the central axes along a longitudinal axis 13 of the vacuum switching tube 1, and closed in each case fluid tightly at the ends of the vacuum switching tube 1. The sleeve 2 forms a switching chamber 16 or surrounds the switching chamber 16 vacuum-tightly. The vacuum switching tube 1 is evacuated on the inside or a vacuum exists therein.

The main shield 6 is made, for example, from a metal, in particular copper and/or steel, and comprises, for example inside it, evaporation shields which are not illustrated in the Figures for the sake of simplicity. The hollow cylindrical ceramic segments 7, 8 are produced, for example, from sintered ceramic and are in particular surface-treated. The ceramic segments 7, 8 comprise, for example, ceramic segment elements which are connected to one another via vapor shields, this not being illustrated in the Figures for the sake of simplicity. A connection is thus made, for example, in a soldering procedure in a furnace at several hundred degrees Celsius, when the vacuum switching tube 1 is produced. The vapor shields are made, for example, from metal, in particular copper and/or steel, and are formed with an annular shape. Inside the vacuum switching tube 1, the vapor shields comprise, for example, evaporation shields which are not illustrated in the Figures for the sake of simplicity. Drawn outward, the vapor shields project, for example, in the form of flat rings from the vacuum switching tube 1 or beyond the circumference of the ceramic segment element. The vapor shields divide a respective ceramic segment 7, 8 into ceramic segment elements.

Contact pieces 3 and 4 project from the ends of the cylindrical vacuum switching tube 1 into the sleeve 2 of the vacuum switching tube 1, for example a fixed contact piece 3 from one side or a base surface of the cylinder and a movable contact piece 4 from the other side or a covering surface of the cylinder. The contact pieces 3 and 4 are formed as bolts or with a cylindrical shape toward the ends outside the vacuum switching tube 1 and are formed as plate-shaped contact piece ends 15 toward the ends in the vacuum switching tube 1, i.e. in the sleeve 2. Two contact piece ends 15, i.e. in each case one contact piece end 15 of the first fixed contact piece 3 and one contact piece end 15 of the second movable contact piece 4, are arranged opposite each other in the sleeve 2, with flat-cylinder or plate shapes arranged parallel to each other. The contact piece ends 15 are, for example, slotted in the opposing surfaces in order to guide arcs onto the surfaces during switching.

The contact pieces 3 and 4 are made, for example, from copper, in particular with a copper, steel, and/or aluminum shaft. The first contact piece 4 is fixedly connected to the sleeve 2, for example, via an in particular metal cover, for example made from steel. The second contact piece 4 is movably mounted in the sleeve 2, for example via an in particular metal bellows 14, for example made from steel. During switching, the movable contact piece 4 is moved toward the fixed contact piece 3, i.e. during switching-on, until an electrical and/or mechanical contact exists between the two contact pieces 3 and 4, or the movable contact piece 4 is moved away from the fixed contact piece 3, i.e. during switching-off, until the electrical and/or mechanical contact between the two contact pieces 3 and 4 is broken, and a gap is formed between the contact pieces 3 and 4. The distance of the gap between the contact pieces 3 and 4 is large enough that no electrical flashovers occur between the contact pieces 3 and 4 when voltage is applied.

During switching, in particular during switching-off, an arc burns between the contact pieces 3 and 4 which is extinguished when there is a sufficient gap distance, depending on the switching voltage. In the switched-on state, the arc can cause welding or a welded connection of the contact pieces 3 and 4 to each other, which is mechanically disconnected by the exertion of sufficient force during switching-off. As a result of disconnecting the plate-shaped contact piece ends 15 during switching-off, and/or as a result of the arc and the movement of the contact pieces 3 and 4, particles 12, in particular burn-up particles, can occur during switching. The particles 12 are deposited in the evacuated sealed sleeve 2 of the vacuum switching tube 1, for example on the inner surfaces of the ceramic segments 7, 8 and/or on the contact pieces 3, 4.

The ceramic segments 7, 8 are made from an electrically insulating ceramic, which, in the switched-off state of the vacuum switching tube 1 with no particles 12, prevents an electrical flashover between the contact pieces 3, 4 when voltage is applied at the contact pieces 3, 4. The space between the contact pieces 3, 4 is insulating owing to a vacuum and, by virtue of the ceramic segments 7, 8, the sleeve 2 is electrically insulating between the contact pieces 3, 4 with the exception of the region of the main shield 6. Particles 12 on the inner surfaces of the ceramic segments 7, 8 can weaken or cancel out the insulating effect, as a result of which electrical flashovers are possible between the contact pieces 3, 4 via the ceramic segments 7, 8 when electrical voltage is applied. These flashovers result in limited functioning of the vacuum switching tube 1 and can cause damage and in extreme cases irreversible destruction of the vacuum switching tube 1.

Particles 12, adsorbed on contact pieces 3, 4, in particular in the region of the contact piece ends 15, can cause flashovers and/or disrupt the guidance of an arc. Furthermore, particles 12 which are, for example, not electrically conductive or have limited electrical conductivity disrupt an electrical and/or mechanical contact of the contact pieces 3 and 4 in the switched-on state and in extreme cases prevent contact.

The situation thus needs to be prevented in which the particles 12 are deposited on the insulating parts of the vacuum switching tube 1 such as, for example, the ceramic segments 7, 8, and/or on the electrically conductive parts such as, for example, the contact pieces 3, 4.

Illustrated schematically in FIG. 2 is a detail of a vacuum switching tube 1 according to the invention, which comprises a device 5 according to the invention for collecting particles 12. The detail illustrates in a view in section the lower half of the vacuum switching tube 1, with a structure according to FIG. 1, and additionally with a chamber 11 as a device 5 for collecting particles 12. The chamber 11 is formed by sloped walls 10 and regions of the main shield 6 of the vacuum switching tube 1. The sloped walls 10 comprise centrally an opening 9, formed for the entry of particles 12 into the chamber 11.

The vacuum switching tube 1 in FIG. 2 is arranged in a horizontal position, with the longitudinal axis 13 of the vacuum switching tube perpendicular to the action of the force of gravity. The longitudinal axis 13 is illustrated as horizontal within the plane of the drawing in FIG. 2. The main shield 6 is arranged, in the region of the plate-shaped contact piece ends 15, in particular centrally in the vacuum switching tube 1, between the first, left-hand ceramic segment 7 and the second, right-hand ceramic segment 8. Additional vapor shields of the main shield 6 are not illustrated in the Figures for the sake of simplicity. The walls 10 can in particular act as vapor shields. The main shield 6 is formed with a hollow cylindrical shape in a similar fashion to the ceramic segments 7, 8, with a larger diameter than the diameter of the ceramic segments 7, 8, wherein the diameter of the main shield 6 decreases to the diameter of the ceramic segments 7, 8 in each case in the region toward the ceramic segments 7, 8. Visible in the view in section is a pot-shaped main shield 6 between the ceramic segments 7, 8 which is closed toward the top by the walls 10, i.e. toward the longitudinal axis 13, with a central opening 9.

The walls 10 are formed as sloping toward the opening 9, i.e. with an increasing distance from the longitudinal axis 13 to the opening 9. The walls 10 thus have an incline leading to the opening 9 which directs particles 12 which fall from the contact pieces 3, 4 or plate-shaped contact piece ends 15 onto the walls 10 under the action of gravity to the opening 9 or moves the particles 12 toward the opening 9 under the action of gravity. The particles 12 pass through the opening 9 and fall into the chamber 11, wherein the particles 12 are “caught” in the chamber by virtue of the small size of the opening 9, i.e. escape from the chamber 11 is generally prevented or obstructed. The size of the opening 9 is, for example, in the range of millimeters up to centimeters, with a chamber size in the range of a few centimeters up to decimeters.

The chamber 11 is formed, for example, as running around the circumference of the vacuum switching tube 1, with a slot as an opening 9 and/or one or more in particular circular openings 9 which are arranged, for example, on a circumference or parallel thereto. Alternatively, the chamber 11 is formed in a region, as illustrated in FIG. 2, which comprises solely the lower region of the vacuum switching tube 1 in a horizontal arrangement, i.e. with a longitudinal axis 13 perpendicular to the direction of the force of gravity, with at least one slot-shaped and/or circular opening 9.

Particles 12 which occur, for example, during switching as a result of in particular abrasion, burn-up, and/or when contact pieces 3, 4 are separated in particular by being ripped from the plate-shaped contact piece ends 15, and which have a maximum diameter which is smaller than the diameter of the opening 9, fall into the chamber 11 under the action of gravity and are collected and retained there. As a result, the collected particles 12 are, for example, not adsorbed on inner surfaces of the ceramic segments 7, 8 and/or on the contact pieces 3, 4, and do not disrupt the switching procedure during further switching and/or do not change the electrical field distribution in the region of the contact pieces 7, 8 or cause any electrical flashovers beyond the ceramic segments 7, 8 in the switched-off state of the vacuum switching tube 1. Damage and/or destruction of the vacuum switching tube by particles 12 can be prevented in this way.

An alternative embodiment of the device 5 according to the invention for collecting particles 12 is illustrated schematically in FIG. 3 in a view in section as a detail of the vacuum switching tube 1, in a similar fashion to FIG. 2, with walls 10 which have a curvature or an increasing incline toward the opening 9.

In a similar fashion to FIG. 2, the detail illustrates the lower half of the vacuum switching tube 1 in a view in section. In contrast to the embodiment of FIG. 2, in FIG. 3 the device 5 for collecting particles 12 comprises walls 10 which do not slope continuously toward the opening 9 and instead have an incline which increases significantly in the region of the opening 9. The walls are curved toward the opening 9, for example with a semicircular curvature, viewed in section, toward the inside of the chamber. By virtue of the additional curvature around the opening 9, particles 12 are moved into the chamber 11 in an accelerated fashion and can be better retained in the latter in particular with a filled chamber 11.

An alternative embodiment of the device 5 according to the invention for collecting particles 12 is illustrated schematically in FIG. 4 in a view in section as a detail of the vacuum switching tube 1, in a similar fashion to FIG. 2, with one instead of two walls 10. In a similar fashion to FIG. 2, the detail illustrates the lower half of the vacuum switching tube 1 in a view in section. The opening 9 is formed on one side of the chamber 11 and the wall 10 has an incline which is in particular continuous into the opening.

A further alternative embodiment of the device 5 according to the invention for collecting particles 12 is illustrated schematically in FIG. 5 in a view in section as a detail of the vacuum switching tube 1, in a similar fashion to FIG. 2, with T-shaped walls 10 which are arranged centrally on the main shield 6. In a similar fashion to FIG. 2, the detail illustrates the lower half of the vacuum switching tube 1 in a view in section. Two chambers 11, to the right and left of the T-shape, are formed as the device 5 by the T-shaped wall or walls 10, with openings 9 arranged in each case at the edge toward the main shield 6 or toward the respective ceramic segment 7, 8.

A further alternative embodiment of the device 5 according to the invention for collecting particles 12 is illustrated schematically in FIG. 6 in a view in section as a detail of the vacuum switching tube 1, in a similar fashion to FIG. 2, with two T-shaped walls 10 which are arranged adjacent to each other centrally on the main shield 6. In a similar fashion to FIG. 2, the detail illustrates the lower half of the vacuum switching tube 1 in a view in section. Three chambers 11, to the right and left of the respective T-shape and centrally between the two T-shapes, are formed by the two adjacent T-shaped walls 10 as the device 5, with openings 9 in each case at the edge toward the main shield 6 or toward the respective ceramic segment 7, 8, and with an opening 9 centrally between the two T-shapes.

A further alternative embodiment of the device 5 according to the invention for collecting particles 12 is illustrated schematically in FIG. 7 in a view in section as a detail of the vacuum switching tube 1, in a similar fashion to FIG. 2, with bent T-shaped walls 10 which are arranged centrally in a U-shaped recess in the main shield 6. In a similar fashion to FIG. 2, the detail illustrates the lower half of the vacuum switching tube 1 in a view in section. Two chambers 11, to the right and left of the T-shape, are formed by the T-shaped wall or walls 10 as the device 5, with openings 9 in each case at the edge toward the main shield 6 or toward the respective ceramic segment 7, 8. The curvature of the T-shape in each case toward the edge of the main shield 6 or toward the respective ceramic segment 7, 8, in the direction of the chamber 11, enables, in a similar fashion to the embodiment of FIG. 3, accelerated movement of the particles 12 into the chamber 11 and better retention of the particles 12 in the chambers 11. The U-shaped recess in the main shield 6 here enlarges the respective internal volume of the chambers and enlarges the distance between the particles 12 in the chamber 11 and critical regions such as, for example, the inner surfaces of the ceramic segments 7, 8 and the intermediate region of the plate-shaped contact piece ends 15. The particles 12 can collect and be retained better in the chamber 11.

A further alternative embodiment of the device 5 according to the invention for collecting particles 12 is illustrated schematically in FIG. 8 in a view in section as a detail of the vacuum switching tube 1, in a similar fashion to FIG. 2, with a U-shaped recess in the main shield 6 as the device 5, arranged centrally in the main shield 6. In a similar fashion to FIG. 2, the detail illustrates the lower half of the vacuum switching tube 1 in a view in section. The region of the main shield 6, which is formed with a U-shape, acts in a similar fashion to the walls 10, with more pronounced collection of the particles 12 in this region in particular owing to the force of gravity and retention of the particles 12 in the region. Further walls 10 for the purpose of retention are not provided in the exemplary embodiment of FIG. 8, as a result of which there is a saving in materials and cost.

A further alternative embodiment of the device 5 according to the invention for collecting particles 12 is illustrated schematically in FIG. 9 in a view in section as a detail of the vacuum switching tube 1, in a similar fashion to FIG. 2, with an elliptical instead of U-shaped recess in the main shield 6 as the device 5, arranged centrally in the main shield 6. In a similar fashion to FIG. 2, the detail illustrates the lower half of the vacuum switching tube 1 in a view in section. The region of the main shield 6, which is formed elliptically, acts in a similar fashion to the walls 10, with more pronounced collection of the particles 12 in this region in particular owing to the force of gravity and retention of the particles 12 in the region. The elliptical shape of the device 5 is formed with an opening 9 in the center of the main shield 6 toward the contact pieces 3, 4 or their plate-shaped ends 15. Further walls 10 for the purpose of retention are not provided in the exemplary embodiment of FIG. 9, as a result of which there is a saving in materials and cost.

A further alternative embodiment of the device 5 according to the invention for collecting particles 12 is illustrated schematically in FIG. 10 in a view in section as a detail of the vacuum switching tube 1, in a similar fashion to FIG. 2, with two U-shaped recesses in the main shield 6 as the device 5 or two V-shaped recesses with a rounded tip, in each case arranged at the sides of the main shield 6 toward the respective ceramic segments 7, 8. In a similar fashion to FIG. 2, the detail illustrates the lower half of the vacuum switching tube 1 in a view in section. The regions of the main shield 6, which are formed with a U-shape or rounded V-shape, act in a similar fashion to the exemplary embodiment of FIG. 8, with more pronounced collection of the particles 12 in these regions in particular owing to the force of gravity and retention of the particles 12 in the regions. Further walls 10 for the purpose of retention are not provided in the exemplary embodiment of FIG. 10, as a result of which there is likewise a saving in materials and cost.

A further alternative embodiment of the device 5 according to the invention for collecting particles 12 is illustrated schematically in FIG. 11 in a view in section as a detail of the vacuum switching tube 1, in a similar fashion to FIG. 2, with two U-shaped recesses in the main shield 6 as the device 5 or two V-shaped recesses with a rounded tip, in each case arranged at the sides of the main shield 6 toward the respective ceramic segments 7, 8, in a similar fashion to the exemplary embodiment of FIG. 10. In addition, in a similar fashion to FIG. 4, in each case sloped walls are arranged above the U-shaped recesses or V-shaped recesses with a rounded tip 10. The walls 10 have a decreasing incline toward a respective opening 9 which is arranged to the side of the chamber 11 which is formed by the walls 10, in the center of the main shield 6. In a similar fashion to FIG. 2, the detail illustrates the lower half of the vacuum switching tube 1 in a view in section. The regions of the main shield 6, which are formed with a U-shape or rounded V-shape, form, in conjunction with the walls 10, chambers 11 which enable more pronounced collection of the particles 12 in these regions, in particular owing to the force of gravity, and retention of the particles 12 in the regions by the walls 10.

The above-described exemplary embodiments can be combined with one another and/or can be combined with the prior art. Thus, for example, a plurality of devices 5 for collecting particles 12 can be formed in a vacuum switching tube 1, in particular with different shapes. Further shapes of the device 5, not illustrated in the exemplary embodiments, are possible. The device 5 can be arranged or formed, for example, in or on the ceramic segments 7 and/or 8 instead of in or on the main shield 6.

The vacuum switching tube 1 can be electrically contacted via the bolts, routed to the outside, of the fixed contact piece 3 and the movable contact piece 4. The movable contact piece 4 enables electrical switching by movement toward the fixed contact piece 3, i.e. to close a gap between the plate-shaped contact piece ends 15 of the contact pieces 3 and 4, during switching-on, and by movement away from the fixed contact piece 3, i.e. to produce a gap between the plate-shaped contact piece ends 15 of the contact pieces 3 and 4, during switching-off. The contact pieces can also both be formed as movable. It is also possible for more than two contact pieces to be provided in a vacuum switching tube 1. The gap produced between the contact piece ends 15 of the contact pieces 3 and 4, as well as the contact piece ends themselves, are arranged in the evacuated interior of the vacuum switching tube 1, as a result of which a gap in the range of millimeters up to centimeters is sufficient for switching off in particular high voltages. The vacuum switching tube 1 has, for example, a length in the range of in particular 30 to 100 centimeters, and a circumference in the range of in particular 10 to 100 centimeters. A plurality of vacuum switching tubes 1 are interconnectable, in particular in series and/or parallel.

Chambers 11 of a vacuum switching tube 1 can have different shapes, in particular the shape of a cube, a tetrahedron, a pyramid, a prism, an octahedron, a cylinder, a cone, and/or a truncated cone, a sphere, and/or a torus. Walls 10 are, for example, made from metal, in particular copper and/or steel, and/or from plastic, and/or from ceramic. The wall thicknesses are, for example, in the range of micrometers to millimeters. The wall surface areas are, for example, in the range of square millimeters to square centimeters. In the case of particles 12 with a diameter for example in the range of micrometers to millimeters, openings 9 are, for example, in the range of millimeters to centimeters. The size of the openings 9 is of the order of the size of the particles or is slightly larger, in particular of the order of the maximum size of particles 12. Chamber volumes are, for example, in the range from cubic millimeters to cubic decimeters.

A disruptive effect of the particles 12 can be diminished or even avoided with the devices 5 for collecting particles 12, in particular abraded and/or burn-up particles of the contact pieces 3, 4. Disruption of the switching procedure and/or the field distribution in the vacuum switching tube 1, short-circuits via particles 12, and damage associated therewith and in extreme cases destruction of the vacuum switching tube 1 can be prevented. The particles 12 are collected and/or retained in a region of the vacuum switching tube 1, in particular in the chambers 11, in which no damage can be caused by the particles. In the method according to the invention for collecting particles 12 in a vacuum switching tube 1, the particles are collected and/or retained in the device 5 in the manner of a chamber 11, in particular by the force of gravity. The device in the manner of a chamber 11 here comprises, for example, also structures which are described above in the exemplary embodiments and have in particular only recesses, for example V-shaped and/or U-shaped recesses with no additional walls 10, in particular in the main shield 6. The particles 12 are moved by the action of the force of gravity into the device 5 and/or can be collected in the device by, for example, electromagnetic fields. The fields can, for example, be formed in such a way that the particles 12 are moved into the device 5, or its movement is assisted, and/or the particles 12 are held in the device.

### LIST OF REFERENCE SIGNS

1 vacuum switching tube
2 sleeve
3 fixed contact piece
4 movable contact piece
5 device for collecting particles
6 main shield, in particular with vapor shield/shields
7 first ceramic segment
8 second ceramic segment
9 opening
10 wall
11 chamber
12 particles, in particular burn-up particles
13 longitudinal axis
14 bellows
15 plate-shaped contact piece end
16 switching chamber or evacuated space

1-12. (canceled)

13. A vacuum switching tube for switching voltages, the vacuum switching tube comprising:
at least one sleeve and at least two contact pieces, said at least one sleeve forming at least one evacuated switching chamber; and
at least one device for collecting particles.

14. The vacuum switching tube according to claim 13, wherein said at least one device for collecting particles is configured to collect the particles by the action of gravity.

15. The vacuum switching tube according to claim 13, wherein said at least one device for collecting particles is a particle trap configured to act by sedimentation of the particles from said at least one evacuated switching chamber.

16. The vacuum switching tube according to claim 13, wherein said at least one device for collecting particles is configured as a separate chamber for collecting the particles and configured to effect a retention of the particles from said contact pieces.

17. The vacuum switching tube according to claim 13, wherein said at least one device for collecting particles is as a chamber integrated into said sleeve and configured to effect a retention of the particles from said contact pieces.

18. The vacuum switching tube according to claim 17, wherein said chamber integrated in said sleeve is arranged at a circumference of the vacuum switching tube and along a longitudinal axis of the vacuum switching tube.

19. The vacuum switching tube according to claim 17, wherein said chamber integrated in said sleeve is arranged at least partially or completely in a region between said contact pieces.

20. The vacuum switching tube according to claim 13, wherein said at least one sleeve comprises at least one main shield and at least two ceramic segments.

21. The vacuum switching tube according to claim 20, wherein said at least one main shield is arranged along a longitudinal axis of the vacuum switching tube between said at least two ceramic segments, and said at least one device for collecting particles is comprised by said at least one main shield.

22. The vacuum switching tube according to claim 13, wherein said at least one device for collecting particles is formed with at least one opening.

23. The vacuum switching tube according to claim 13, wherein said at least one opening is an opening of at least one separate chamber for collecting particles.

24. The vacuum switching tube according to claim 13, wherein the vacuum switching tube is a horizontal vacuum switching tube with a longitudinal axis of the vacuum switching tube being parallel to the earth's surface, and wherein said least one device for collecting particles is formed exclusively in a lower region of said sleeve of the vacuum switching tube.

25. The vacuum switching tube according to claim 13, wherein said at least one device for collecting particles is formed by walls, and wherein at least one of the following is true:
said walls are formed with, or form, at least one opening;
said walls are formed to slope toward said at least one opening;
said walls are T-shaped; or
said walls are U-shaped and/or V-shaped.

26. The vacuum switching tube according to claim 25, wherein said walls are formed to slope toward said at least one opening at a non-zero angle with reference to a longitudinal axis of the vacuum switching tube.

27. The vacuum switching tube according to claim 25, wherein said walls are formed with at least one of U-shaped or V-shaped recesses.

28. The vacuum switching tube according to claim 13, wherein said at least one device for collecting particles has at least one cross section selected from the group consisting of an elliptical, a square, and a circular cross section.

29. The vacuum switching tube according to claim 13, wherein the vacuum switching tube is configured for switching high voltages.

30. The vacuum switching tube according to claim 13, wherein the vacuum switching tube is configured for switching voltages above 52 kV.

31. A method for collecting particles in a vacuum switching tube, the method comprising:
providing a vacuum switching tube with a device for collecting particles, the particles being burn-up particles from contact pieces of the vacuum switching tube; and
collecting the particles in the device in the manner of a chamber and/or retaining the particles from the contact pieces due to the force of gravity.

32. The method according to claim 31, wherein the step of providing the vacuum switching tube with a device for collecting the particles comprises providing a vacuum switching tube having at least one sleeve and at least two contact pieces, with the at least one sleeve forming at least one evacuated switching chamber, and at least one device for the collecting particles.
